(19) United States
(12) Patent Application Publication
(10) Pub. No.: US 2015/0136763 A1
(43) Pub. Date: May 21, 2015

(54) TOOL BOX WITH QUICK RELEASE STRUCTURE

(71) Applicant: RE-DAI PRECISION TOOLS CO., LTD., Taichung City (TW)

(72) Inventor: Yi Chiu CHOU, Taichung City (TW)

(73) Assignee: RE-DAI PRECISION TOOLS CO., LTD., Taichung City (TW)

(21) Appl. No.: 14/224,121

(22) Filed: Mar. 25, 2014

(30) Foreign Application Priority Data
Nov. 19, 2013 (TW) 102221614

(51) Int. Cl. B25H 3/02

(52) U.S. Cl. CPC B25H 3/02
USPC 220/4.21

(57) ABSTRACT

A tool box with a quick release structure includes a first box body having one side integrally formed jointly with a first hook portion and a first shaft; and a second box body having one side integrally formed jointly with a second hook portion and a second shaft. The first hook portion hooks the second shaft, and the second hook portion hooks the first shaft. Thus, the first box body and the second box body can be combined together and form openable and closeable states. Because the first box body, the first hook portion and the first shaft can be integrally formed as a structure form the same as the structure form constituted by the second box body, the second hook portion and the second shaft, which can also be integrally formed, the object and effect of simplifying the structure can be achieved. In addition, the corresponding hook portion and shaft can be combined together through the simple penetrating and hooking actions, and the crossing and rotating actions can separate the two box bodies from each other in the state when the tool box is opened, so that the effects of the simple and convenient operations are achieved.

### BACKGROUND OF THE INVENTION

1. Field of the Invention

The invention relates to the technical field of a tool box, and more particularly to a tool box with a quick release structure by forming quick releasing and assembling mechanisms on a lateral side of the tool box.

2. Related Art

Typically, a tool box includes two box bodies, and at least one of the box bodies has an inner surface formed with one chamber or multiple chambers for accommodating tools. In addition, a pivot structure has to be provided between the two box bodies so that the two box bodies can be opened and closed relatively to each other.

A conventional pivot structure is composed of a shaft and a bearing tube. For example, one side of each box body may be formed with two bearing tubes. When one side of the box body rests against one side of the other box body, four bearing tubes can be paired and the bearing tubes of each pair can rest against each other and form a line, so that the shaft can pass through each bearing tube, and the two box bodies can be combined with each other and can be opened. This conventional structure causes inconvenient in the assembling operation.

In another design of a pivot structure, one side of a box body is formed with two bearing tubes, and one side of the other box body has two projecting shafts each having one end being a free end, as shown in, for example, Taiwan Patent No. 1406747, which discloses the first shaft and the second pivoting structure of the tool box structure. This structure has two different structures of box bodies, so more production apparatuses are needed to manufacture the box bodies, and the cost is significantly higher.

Also, Taiwan Patent No. 1341776 discloses a tool box that can be quickly disassembled and assembled, wherein two pivotally connecting units are mounted between the two box bodies that can be opened and closed relatively to each other. Each pivotally connecting unit includes a pin and a spring combined together. Pulling of the pin to compress the spring and the displacement of each pin can release the combined state of the two box bodies. Although the mechanism design of this patent can separate the two box bodies from each other, an operator who uses two hands to pull the two pins has no additional hand to move any box body. So, the operation is inconvenient. Even if the force is directly applied to the pin to move one of the box bodies, the operation process is also inconvenient.

### SUMMARY OF THE INVENTION

An object of the invention is to provide a tool box with a quick release structure, wherein the structure is simple and the operation is convenient.

To achieve the above-mentioned object, the invention discloses a tool box structure including a first box body and a second box body. One side of the first box body is integrally formed jointly with a first hook portion and a first shaft. One side of the second box body is integrally formed jointly with a second hook portion and a second shaft. In addition, the first hook portion hooks the second shaft, and the second hook portion hooks the first shaft. Thus, the first box body and the second box body can be combined with each other and form openable and closeable states.

Because the structure form, which is constituted by the first box body, the first hook portion and the first shaft that may be integrally formed, is the same as the structure form, which is constituted by the second box body, the second hook portion and the second shaft that may be integrally formed, the effect and object of the simple structure can be achieved.

Also, using the simple penetrating and hooking actions can combine the hook portion with the shaft. In addition, when the tool box is in the opened state, using the crossing and rotating actions can separate the two box bodies from each other, so the effects of the simple and convenient operations can be achieved.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is an assembled pictorial view of the invention.

FIG. 2 is an outlook view showing a deployed state of a first box body and a second box body of the invention.

FIG. 3 is a partial structure view showing the first box body of the invention.

FIG. 4 is an enlarged view showing a portion A in FIG. 3 of the invention.

FIG. 5 is a partial structure view showing the second box body of the invention.

FIG. 6 is an enlarged view showing a portion B in FIG. 5 of the invention.

FIG. 7 is a schematic view showing the first box body and the second box body of the invention before being assembled.

FIG. 8 shows an operation for separating the first box body from the second box body according to the invention.

### DETAILED DESCRIPTION OF THE INVENTION

The present invention will be apparent from the following detailed description, which proceeds with reference to the accompanying drawings, wherein the same references relate to the same elements.

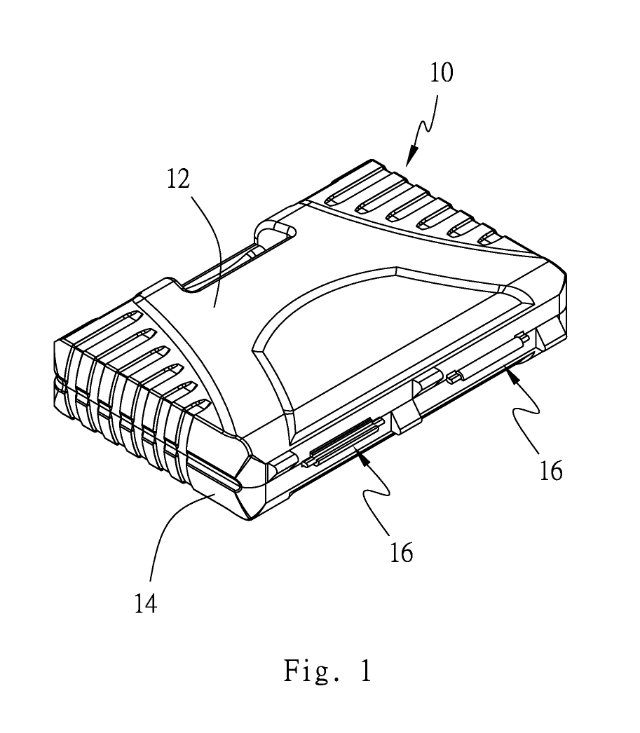

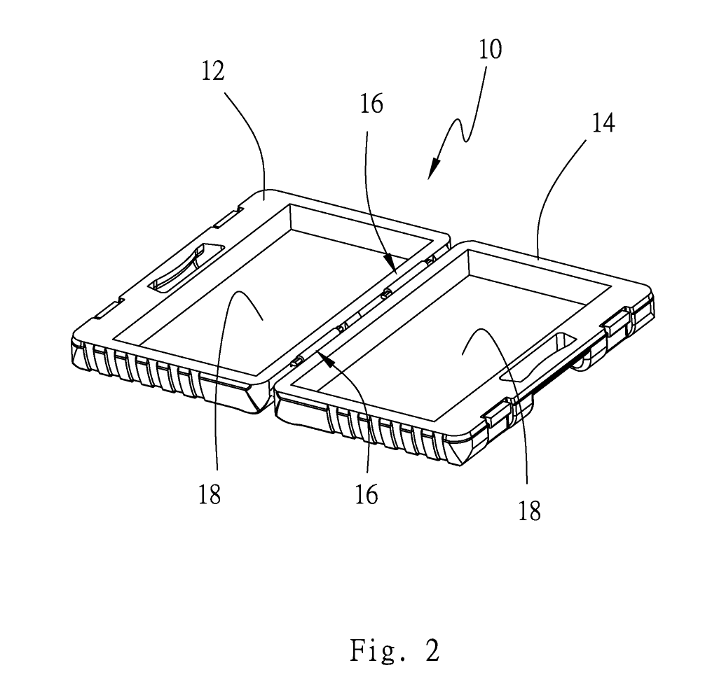

Referring to FIGS. 1 and 2, a tool box 10 of the invention includes a first box body 12 and a second box body 14. After the first box body 12 and the second box body 14 are assembled together using a pivoting mechanism 16, the first box body 12 and the second box body 14 of the tool box 10 can be opened and closed relatively to each other. Next, as shown in FIG. 2, inner surfaces of the first box body 12 and the second box body 14 may form a chamber 18 for accommodating objects, such as hand tools or the like.

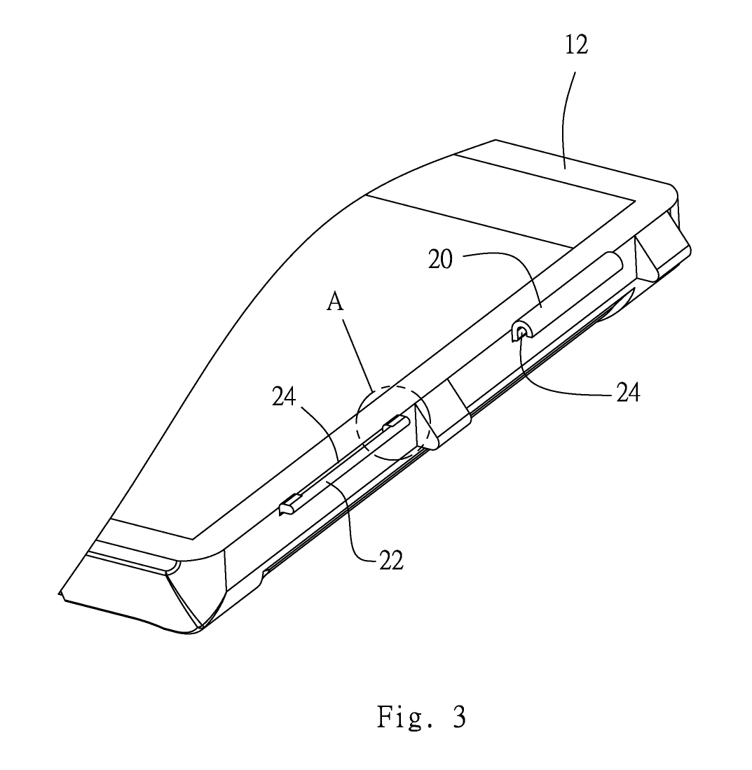

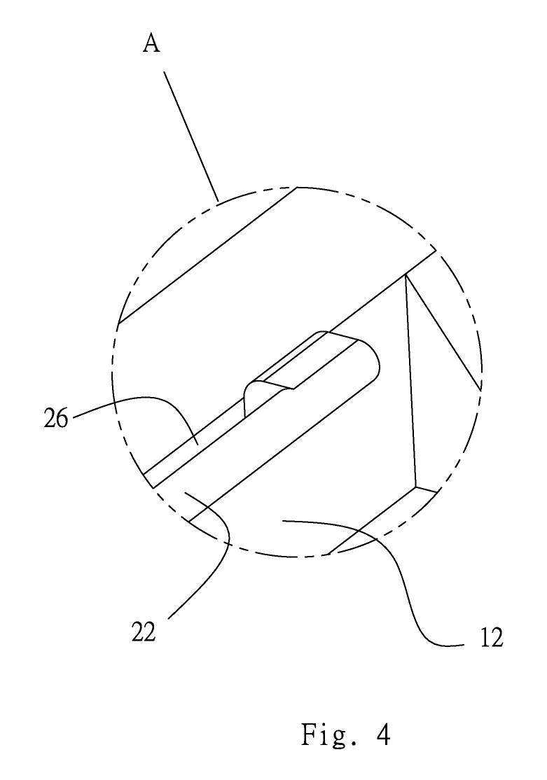

Referring to FIG. 3, a first hook portion 20 and a first shaft 22 are disposed on one side of the first box body 12. The first hook portion 20 and the first shaft 22 are disposed on the same side of the first box body 12 and neighbor each other. The first hook portion 20 and the first shaft 22 are integrally formed jointly with the first box body 12. For example, the first hook portion 20, the first shaft 22 and the first box body 12 are integrally formed together by way of blow molding. In addition, one side of the first hook portion 20 is an opening side 24. Referring further to FIGS. 3 and 4, a first gap 26 is formed between the first shaft 22 and the first box body 12.

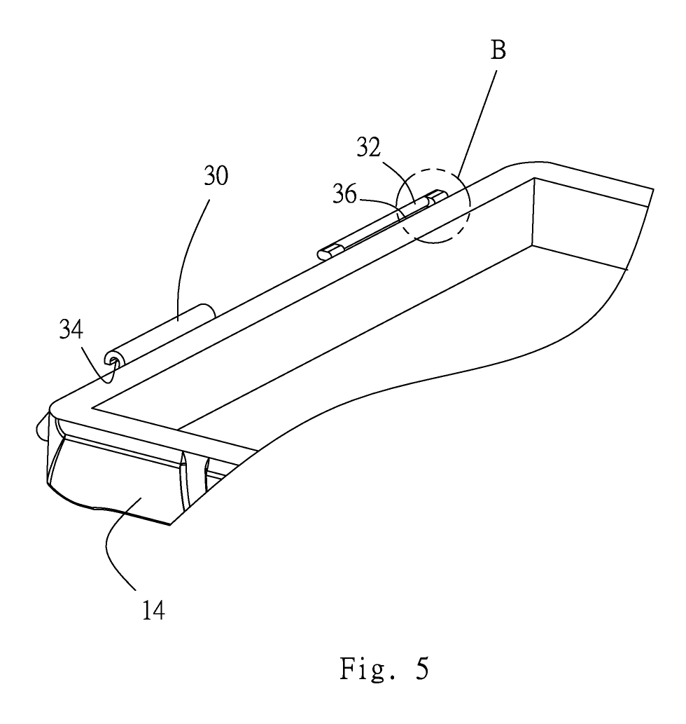

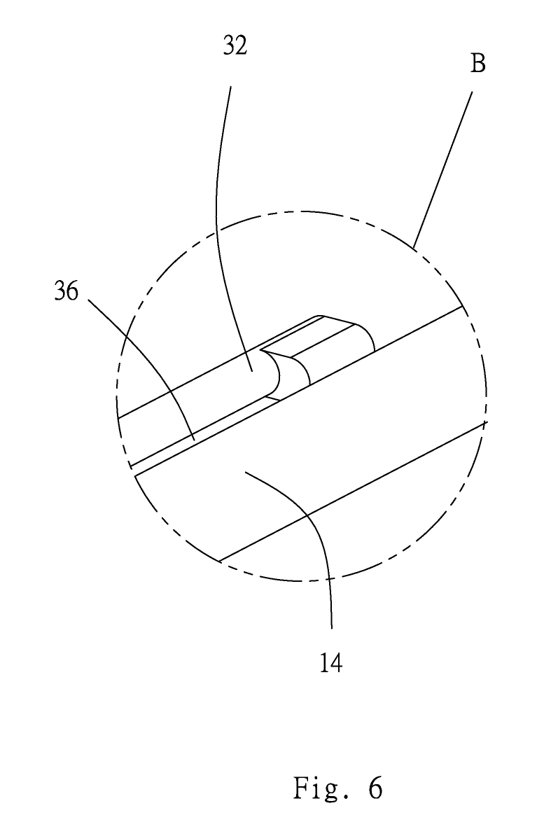

Referring to FIG. 5, a second hook portion 30 and a second shaft 32 are disposed on one side of the second box body 14. The second hook portion 30 and the second shaft 32 are disposed on the same side of the second box body 14 and neighbor each other. The second hook portion 30 and the second shaft 32 are integrally formed jointly with the second box body 14. For example, the second hook portion 30, the second shaft 32 and the second box body 14 are integrally formed together by way of blow molding. In addition, one side of the second hook portion 30 is an opening side 34. Referring further to FIGS. 5 and 6, a second gap 36 is formed between the second shaft 32 and the second box body 14.

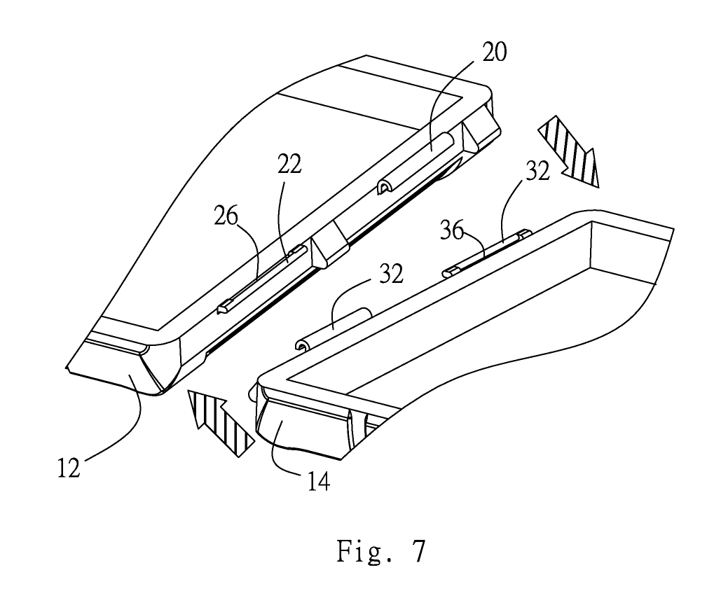

Referring to FIG. 7, the first box body 12 and the second box body 14 may be combined together using the first hook portion 20 passing through the second gap 36, and the second hook portion 30 passing through the first gap 26, so that the first hook portion 20 and the second shaft 32 are connected together and the second hook portion 30 and the first shaft 22 are connected together, as shown in FIG. 2.

When the first box body 12 and the second box body 14 form the closed state, the assembled configuration of the first hook portion 20 and the second shaft 32, and the assembled configuration of the second hook portion 30 and the first shaft 22 can avoid the separation of the first box body 12 from the second box body 14.

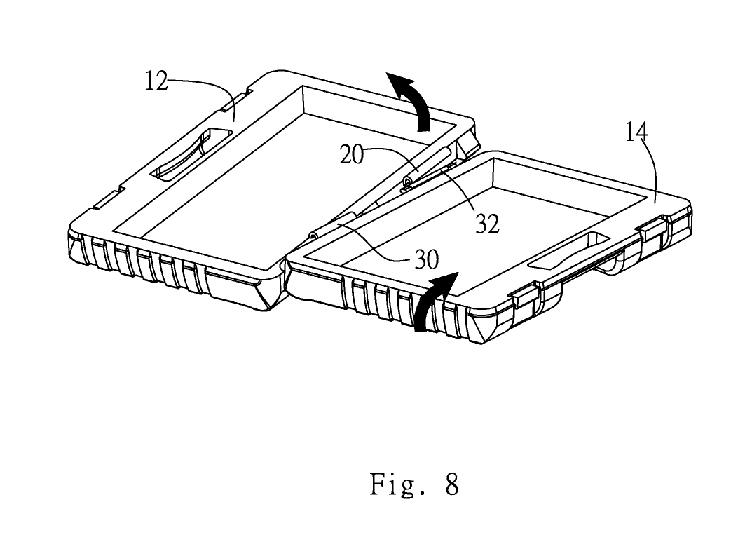

As shown in FIG. 8, in the state when the first box body 12 and the second box body 14 are relatively opened to form an angle of 180 degrees, the user can twist the first box body 12 or the second box body 14 so that the first hook portion 20 is separated from the second shaft 32, and the second hook portion 30 can be separated from the first shaft (not shown). In other words, the user only needs a simple twist operation to separate the first box body 12 from the second box body 14.

In summary, the combination of the first hook portion 20 and the second shaft 32 and the combination of the second hook portion 30 and the first shaft 22 constitute the pivoting mechanism 16 of the invention, as shown in FIG. 1. Also, a structure form constituted by the first box body 12, the first hook portion 20 and the first shaft 22 and relative positional relationships between the first box body 12, the first hook portion 20 and the first shaft 22 are the same as a structure form constituted by the second box body 14, the second hook portion 30 and the second shaft 32 and relative positional relationships between the second box body 14, the second hook portion 30 and the second shaft 32. Thus, only one kind of box bodies need to be manufactured in the actual production, and two of the box bodies can be combined to form a tool box using the combination of the hook portion and the shaft. So, the invention has the effect of the simple structure, and the assembling operation of the tool box further has the quick and simple effects. In addition, when the tool box needs to be separated into two independent box bodies, only the simple crossing and rotating actions need to be applied to achieve this object, so that the effect of the simple operation is obtained.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A tool box with a quick release structure, the tool box comprising:
a first box body;
a second box body;
a first shaft formed on one side of the first box body;
a first hook portion, which is formed on the one side of the first box body, and neighbors the first shaft;
a second shaft formed on one side of the second box body; and
a second hook portion, which is formed on the one side of the second box body, and neighbors the second shaft, wherein:
the first hook portion is for hooking the second shaft, and the second hook portion is for hooking the first shaft, so that the first box body and the second box body can be combined and form openable and closeable states.

2. The tool box according to claim 1, wherein a first gap is formed between the first shaft and the first box body, a second gap is formed between the second shaft and the second box body, the first hook portion passes through the second gap and is combined with the second shaft, and the second hook portion passes through the first gap and is combined with the first shaft.

3. The tool box according to claim 1, wherein the first hook portion, the first shaft and the first box body are integrally formed together.

4. The tool box according to claim 1, wherein the second hook portion, the second shaft and the second box body are integrally formed together.

5. The tool box according to claim 1, wherein a structure form constituted by the first box body, the first hook portion and the first shaft and relative positional relationships between the first box body, the first hook portion and the first shaft are the same as a structure form constituted by the second box body, the second hook portion and the second shaft and relative positional relationships between the second box body, the second hook portion and the second shaft.
